(19) United States
(12) Patent Application Publication
(10) Pub. No.: US 2022/0049447 A1
(43) Pub. Date: Feb. 17, 2022

(54) SLOPE STABILITY LIMIT EQUILIBRIUM CALCULATION METHOD BASED ON DISTRIBUTION CHARACTERISTICS OF AN INTERSLICE NORMAL FORCE

(71) Applicant: KUNMING UNIVERSITY OF SCIENCE AND TECHNOLOGY, Kunming (CN)

(72) Inventors: Shunchuan WU, Kunming (CN); Longqiang HAN, Beijing (CN); Xiaoqiang ZHANG, Kunming (CN); Haiyong CHENG, Kunming (CN); Yi REN, Beijing (CN)

(73) Assignee: KUNMING UNIVERSITY OF SCIENCE AND TECHNOLOGY, Kunming (CN)

(21) Appl. No.: 17/274,792

(22) PCT Filed: Mar. 20, 2020
(86) PCT No.: PCT/CN2020/080451

§ 371 Date: Mar. 10, 2021

(30) Foreign Application Priority Data
Apr. 3, 2019 (CN) 201910266211.2

(51) Int. Cl. E02D 1/02; G06F 30/10

(52) U.S. Cl. CPC E02D 1/02; E02D 17/20; G06F 30/10

(57) ABSTRACT

The traditional limit equilibrium slice method does not consider the distribution of the interslice normal force when analyzing the slope stability. That is, the present invention takes into consideration the distribution of the acting positions of the thrust line, and thus provides a slope stability limit equilibrium calculation method based on the distribution characteristics of the interslice normal force. For the deep concave slip surface, it is found that the improved limit equilibrium method and the traditional limit equilibrium method have a large error in the safety factor, which is as high as about 20%. The method of the present invention has the characteristics of simplicity and reliability, and will provide more accurate results for slope stability analysis.

### TECHNICAL FIELD

The present invention relates to a slope stability limit equilibrium calculation method based on distribution characteristics of an interslice normal force, and belongs to the technical field of slope stability.

### BACKGROUND

The limit equilibrium slice method is a slope stability analysis method commonly used in the field of geotechnical engineering. Its principle is to divide a rock mass into a series of slices, and analyze the forces acting on each slice according to principles of limit equilibrium to solve the safety factor of the slope. The limit equilibrium method can also be divided into Fellenius method, simplified Bishop method, Spencer method, Morgenstern-Price method and others according to different equilibrium conditions and different assumptions of force between slices. Duncan, Shunchuan W U, et al. made a comparative analysis of the calculation accuracy of each of these methods, and identified the applicable scope of the different methods. In view of the problems in the limit equilibrium slice method, scholars in China and other countries have carried out numerous studies and have advanced several improvements to the established calculation methods. For example, Zuyu CHEN proposed the general equilibrium equation of the slice method on the basis of summarizing the limit equilibrium slice method of soil slopes, which solves the potential problem of numerical convergence. Dayong Z H U, et al. derived a more concise and practical safety factor calculation formula again, which solves the problem of calculation non-convergence in the limit equilibrium slice method, and improves the calculation speed and accuracy. According to the principle of plastic mechanics, Guangdian Z H O U, et al. considered all the interslice forces and thus proposed an improved slice method based on the traditional limit equilibrium method. Xiujun LIU solved the angle of the interslice force according to the classical earth pressure theory and the boundary conditions of the ends of the slices, which eliminates the need for the traditional Spencer method to blindly assume a series of angles. Zhen WANG, et al. introduced the “shear stress-shear displacement constitutive model” to establish an improved Janbu method that takes into account the relationship between the shear resistance of rock mass and the shear displacement. Ying ZHENG, et al. defined a shape parameter of a slip surface relative to the slice interface, and modified the interslice shear equation of the Sarma method. Fredlund, Zuyu CHEN, et al. extended the two-dimensional limit equilibrium method to three dimensions, and made reasonable assumptions about the stress of the slip surface, which made the calculation results more realistic.

Various corrections and optimizations have been made to the limit equilibrium slice method in the prior art, but few prior limit equilibrium methods consider the distribution of the interslice normal force, namely the influence of different acting positions of the thrust line. The traditional slice method assumes that the position of the thrust line is at the bottom of the slice, ignoring the influence of other positions on the calculation results. In fact, the influence of the distribution of the interslice normal force on the calculation results is not negligible.

### SUMMARY

The traditional limit equilibrium slice method does not consider the distribution of the interslice normal force when analyzing the slope stability. In addition to the influence of different acting positions of the thrust line on the safety factor, on the basis of the prior limit equilibrium slice method, the present invention further considers distribution characteristics of an interslice normal force. That is, the present invention takes into consideration the distribution of the acting positions of the thrust line, and thus provides a slope stability limit equilibrium calculation method based on the distribution characteristics of the interslice normal force. The present invention provides a more complete, widely used, and effective calculation method for the slope stability limit equilibrium method to avoid unnecessary or excessive slope protection measures, which is of practical significance to the slope stability calculation method.

A slope stability limit equilibrium calculation method based on distribution characteristics of an interslice normal force includes the flowing steps:

(1) vertically dividing a given slip body into a plurality of slices of equal width, wherein in the traditional limit equilibrium Spencer method, assuming that forces between the slices are parallel to each other, that is, θᵢ=θ is a constant, an interslice resultant force ΔP between two sides of the slice is the difference between interslice forces of the two sides of the slice, and is expressed as:

$$Δ {P}_{i} = {P}_{i + 1} - {P}_{i} = \frac{\frac{{c}_{i} {l}_{i}}{F} + \frac{tan {φ}_{i}}{F} {W}_{i} cos {α}_{i} - {W}_{i} sin {α}_{i}}{cos ( {α}_{i} - θ ) [ 1 + \frac{tan {φ}_{i}}{F} tan ( {α}_{i} - θ ) ]} \qquad ( 1 )$$

where, ΔPᵢ is an interslice resultant force between two sides of the i^{th} slice, Pᵢ is an interslice force of the i^{th} slice, Pᵢ₊₁ is an interslice force of the (i+1)^{th} slice, Eᵢ is a normal component force of Pᵢ, cᵢ is a cohesive force of the i^{th} slice, lᵢ is a length of the bottom surface of the i^{th} slice, F is a safety factor, Wᵢ is a weight of the i^{th} slice, φᵢ is an internal friction angle of the i^{th} slice, and θᵢ is the angle between the interslice force Pᵢ and the normal component force Eᵢ; the forces between the slices are parallel to each other, that is, θᵢ=θ is a constant;

(2) when a slip surface is a circular arc slip surface, with respect to an entire slope, sum of interslice resultant forces of the slices being 0, that is:

Σ(Pᵢ₊₁−Pᵢ)=0 (2);

(3) in the process of solving a moment equilibrium of the slice, assuming that the interslice resultant force ΔP of each slice acts on the bottom surface of the slice, a tangential component force of the interslice resultant force ΔP on the slip surface being (Pᵢ₊₁−Pᵢ)cos(αᵢ−θ), a force arm from the tangential component force to a rotation center O being Rᵢ, establishing an overall moment equilibrium equation as:

Σ(Pᵢ₊₁−Pᵢ)cos(αᵢ=θ)Rᵢ=0 (3);

(4) since the interslice normal force along the depth of the slice presents a uniform distribution, a triangular distribution, a trapezoidal distribution or a half-sine distribution, according to a definite integral and a resultant moment principle, when the interslice normal force along the depth of the slice presents the uniform distribution, the trapezoidal distribution or the half-sine distribution, an acting point of the resultant force being located at ½ above the bottom of the slice, and expressing the force arm from the tangential component force of the interslice resultant force ΔP on the slip surface to the rotation center O as:

Rᵢ′=Rᵢ−½hᵢ cos αᵢ (4);

when the interslice normal force along the depth of the slice presents the triangular distribution, the acting point of the resultant force being located at ⅓ above the bottom of the slice, and expressing the force arm from the tangential component force of the interslice resultant force ΔP on the slip surface to the rotation center O as:

Rᵢ″=Rᵢ−⅓hᵢ cos αᵢ (5);

substituting Rᵢ′ of the equation (4) into the equation (3), and establishing the overall moment equilibrium equation as:

ΣΔP cos(αᵢ−θ)(Rᵢ−½hᵢ cos αᵢ)=0 (6);

substituting Rᵢ″ of the equation (5) into the equation (3), and establishing the overall moment equilibrium equation as:

ΣΔP cos(αᵢ−θ)(Rᵢ−⅓hᵢ cos αᵢ)=0 (7);

where, hᵢ is a height of the slice;

(5) measuring the central height hᵢ of the slice and an inclination angle αᵢ of the bottom surface of the slice on a graph of the given slip body, and selecting different θ; with respect to the different θ, solving a safety factor F_{f} meeting an overall force equilibrium according to the equation (1), and solving a safety factor Fₘ meeting an overall moment equilibrium according to the equation (6) or the equation (7); and

(6) drawing a F_{f}−θ relationship curve and a Fₘ−θ relationship curve based on the F_{f} and the Fₘ obtained in step (5), obtaining F and θ meeting the force equilibrium and the moment equilibrium at the same time from an intersection of the two curves, wherein the corresponding F is the required safety factor.

The present invention has the following advantages.

(1) The present invention is based on the traditional limit equilibrium Spencer method, and considers the distribution characteristics of the interslice normal force to improve the limit equilibrium Spencer method. Using the improved limit equilibrium Spencer method provided by the present invention to calculate the deep concave slip surface, it is found that the improved limit equilibrium method and the traditional limit equilibrium method have a large error in the safety factor, and the error value is as high as about 20%.

(2) The method of the present invention has the characteristics of simplicity and reliability, and will provide more accurate results for slope stability analysis, which can not only improve the engineering safety, but also save the construction costs and improve the engineering economic benefits.

### BRIEF DESCRIPTION OF THE DRAWINGS

FIG. 1 is a schematic diagram of the slope slice division of the calculation model of the Spencer method;

FIG. 2 is a schematic diagram of the forces acting on the i^{th} slice of the calculation model of the Spencer method;

FIG. 3 shows that the interslice normal force present a uniform distribution;

FIG. 4 shows that the interslice normal force present a triangular distribution;

FIG. 5 shows that the interslice normal force present a trapezoidal distribution;

FIG. 6 shows that the interslice normal force present a half-sine distribution;

FIG. 7 is a schematic diagram of the force acting on the i^{th} slice when the acting point of the resultant force is located at ½ above the bottom of the slice according to Embodiment 3;

FIG. 8 is a schematic diagram of the force acting on the i^{th} slice when the acting point of the resultant force is located at ⅓ above the bottom of the slice according to Embodiment 2;

FIG. 9 is a schematic diagram of solving the safety factor F;

FIG. 10 is a schematic diagram showing a shallow slip model according to Embodiments 2 and 3 and comparative example;

FIG. 11 is a schematic diagram showing the calculation results of the safety factor F of the slip surface 3 of the shallow slip model according to Embodiments 2 and 3 and comparative example;

FIG. 12 is a schematic diagram showing a deep slip model according to Embodiments 2 and 3 and comparative example;

FIG. 13 is a schematic diagram showing the calculation results of the safety factor F of the slip surface 3 of the deep slip model according to Embodiments 2 and 3 and comparative example;

FIG. 14 is a schematic diagram showing the calculation results of the safety factor F of the slip surface 6 of the deep slip model according to Embodiments 2 and 3 and comparative example;

FIG. 15 is a schematic diagram showing the comparison of the calculation results of a deep foundation pit obtained by separately using the methods of Embodiments 2 and 3 and comparative example according to Embodiment 4;

FIG. 16 is a schematic diagram showing the comparison of the calculation results of the supporting scheme 1 obtained by separately using the calculation methods of Embodiment 2 and comparative example according to Embodiment 5; and

FIG. 17 is a schematic diagram showing the comparison of the calculation results of the supporting scheme 2 obtained by separately using the calculation methods of Embodiment 2 and comparative example according to Embodiment 5.

### DETAILED DESCRIPTION OF THE EMBODIMENTS

The present invention will be further described in detail below with reference to specific embodiments, but the scope of protection of the present invention is not limited to the described content.

Embodiment 1: A slope stability limit equilibrium calculation method based on distribution characteristics of an interslice normal force includes the following specific steps.

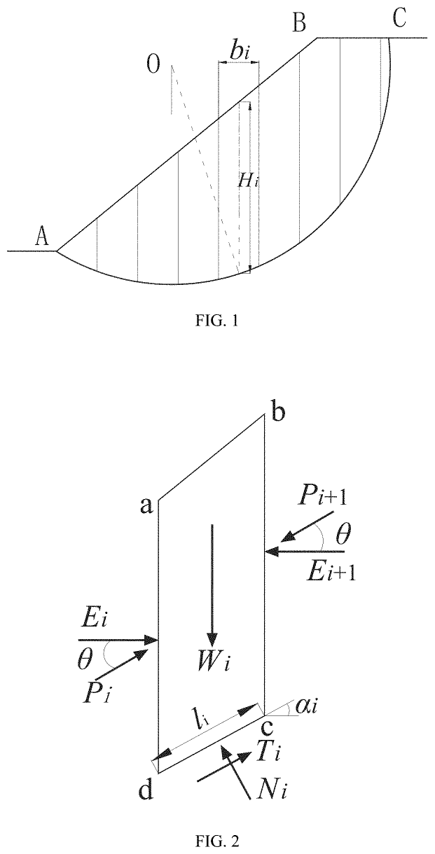

(1) A given slip body is vertically divided into a plurality of slices of equal width (shown in FIG. 1). In the traditional limit equilibrium Spencer method, the schematic diagram of the forces acting on the i^{th} slice of the calculation model of the Spencer method is shown in FIG. 2, assuming that the forces between the slices are parallel to each other, that is, θᵢ=θ is a constant, the interslice resultant force ΔP between two sides of the slice is the difference between the interslice forces of the two sides of the slice, and is expressed as:

$$Δ {P}_{i} = {P}_{i + 1} - {P}_{i} = \frac{\frac{{c}_{i} {l}_{i}}{F} + \frac{tan {φ}_{i}}{F} {W}_{i} cos {α}_{i} - {W}_{i} sin {α}_{i}}{cos ( {α}_{i} - θ ) [ 1 + \frac{tan {φ}_{i}}{F} tan ( {α}_{i} - θ ) ]} . \qquad ( 1 )$$

(2) When the slip surface is a circular arc slip surface, with respect to the entire slope, the sum of the interslice resultant forces of the slices is 0, that is:

Σ(Pᵢ₊₁−Pᵢ)=0 (2).

(3) In the process of solving the moment equilibrium of the slice, assuming that the interslice resultant force ΔP of each slice acts on the bottom surface of the slice, the tangential component force of the interslice resultant force ΔP on the slip surface is (Pᵢ₊₁−Pᵢ)cos(αᵢ−θ), the force arm from the tangential component force to the rotation center O is Rᵢ, and the overall moment equilibrium equation is established as:

Σ(Pᵢ₊₁−Pᵢ)cos(αᵢ−θ)Rᵢ=0 (3).

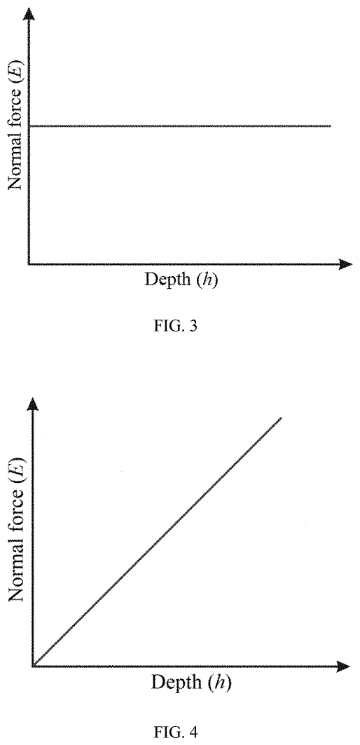

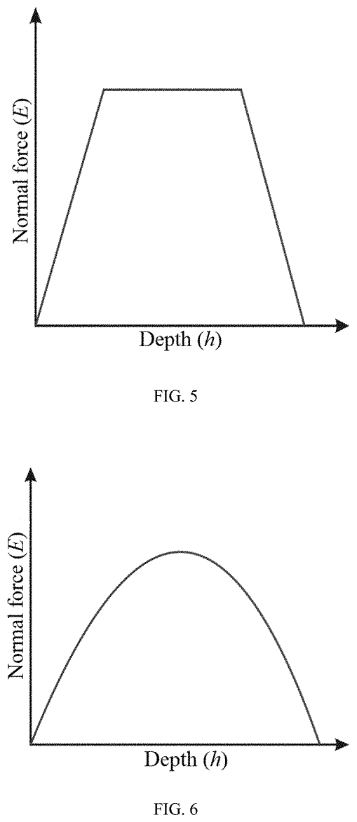

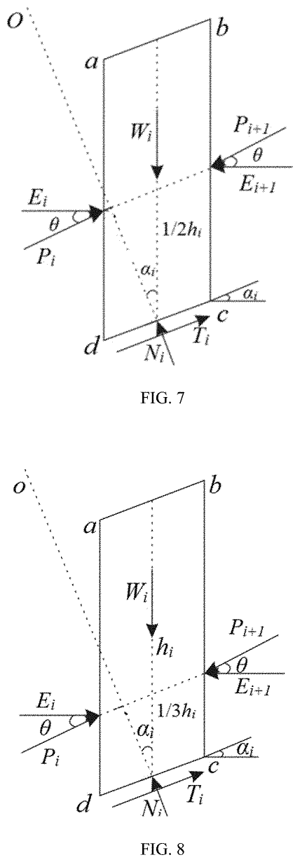

(4) The interslice normal force along the depth of the slice presents a uniform distribution (shown in FIG. 3), a triangular distribution (shown in FIG. 4), a trapezoidal distribution (shown in FIG. 5) or a half-sine distribution (shown in FIG. 6). According to the definite integral and the resultant moment principle, when the interslice normal force along the depth of the slice presents the uniform distribution, the trapezoidal distribution or the half-sine distribution, the acting point of the resultant force is located at ½ above the bottom of the slice, and the force arm from the tangential component force of the interslice resultant force ΔP on the slip surface to the rotation center O is expressed as:

Rᵢ′=Rᵢ−½hᵢ cos αᵢ (4)

When the interslice normal force along the depth of the slice presents the triangular distribution, the acting point of the resultant force is located at ⅓ above the bottom of the slice, and the force arm from the tangential component force of the interslice resultant force ΔP on the slip surface to the rotation center O is expressed as:

Rᵢ″=Rᵢ−⅓hᵢ cos αᵢ (5)

Rᵢ′ of the equation (4) is substituted into the equation (3), then the overall moment equilibrium equation is established as:

ΣΔP cos(αᵢ−θ)(Rᵢ−½hᵢ cos αᵢ)=0 (6)

Rᵢ″ of the equation (5) is substituted into the equation (3), then the overall moment equilibrium equation is established as:

ΣΔP cos(αᵢ−θ)(Rᵢ−⅓hᵢ cos αᵢ)=0 (7)

where, hᵢ is the height of the slice.

(5) The central height hᵢ of the slice and the inclination angle αᵢ of the bottom surface of the slice are measured on the graph of the given slip body, and different θ are selected. With respect to different θ, the safety factor F_{f} that meets the overall force equilibrium is solved according to equation (1), and the safety factor Fₘ in different distributions of the interslice normal force that meets the overall moment equilibrium is solved according to equation (6) or equation (7).

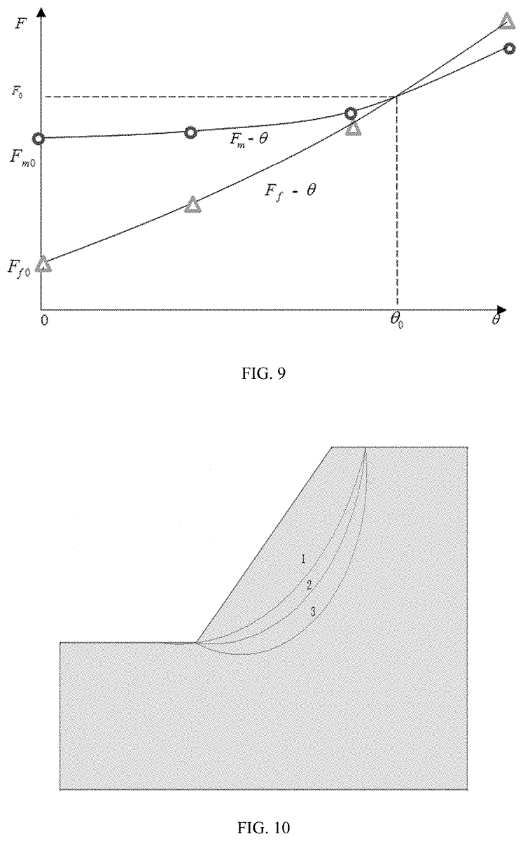

(6) The F_{f}−θ relationship curve and the Fₘ−θ relationship curve are drawn based on the F_{f} and Fₘ obtained in step (5), so F and θ that meet the force equilibrium and moment equilibrium at the same time are obtained from the intersection of the two curves, and the corresponding F is the required safety factor (shown in FIG. 9).

Comparative example: A slope stability limit equilibrium calculation method according to the traditional limit equilibrium Spencer method includes the following steps.

(1) A given slip body is vertically divided into a plurality of slices of equal width (shown in FIG. 1). In the traditional limit equilibrium Spencer method, the schematic diagram of the forces acting on the i^{th} slice of the calculation model of the Spencer method is shown in FIG. 2, assuming that the forces between the slices are parallel to each other, that is, θᵢ=θ is a constant, the interslice resultant force ΔP between two sides of the slice is the difference between the interslice forces of the two sides of the slice, and is expressed as:

$$Δ {P}_{i} = {P}_{i + 1} - {P}_{i} = \frac{\frac{{c}_{i} {l}_{i}}{F} + \frac{tan {φ}_{i}}{F} {W}_{i} cos {α}_{i} - {W}_{i} sin {α}_{i}}{cos ( {α}_{i} - θ ) [ 1 + \frac{tan {φ}_{i}}{F} tan ( {α}_{i} - θ ) ]} . \qquad ( 1 )$$

(2) When the slip surface is a circular arc slip surface, with respect to the entire slope, the sum of the interslice resultant forces of the slices is 0, that is:

Σ(Pᵢ₊₁−Pᵢ)=0 (2).

(3) In the process of solving the moment equilibrium of the slice, assuming that the interslice resultant force ΔP of each slice acts on the bottom surface of the slice, the tangential component force of the interslice resultant force ΔP on the slip surface is (Pᵢ₊₁−Pᵢ)cos(αᵢ−θ), the force arm from the tangential component force to the rotation center O is Rᵢ, and the overall moment equilibrium equation is established as:

Σ(Pᵢ₊₁−Pᵢ)cos(αᵢ−θ)Rᵢ=0 (3).

(4) When the slip surface is shaped as a circular arc, that is, Rᵢ is the radius of the arc, and Rᵢ is a constant with respect to all slices, so the above equation can be written as:

Σ(Pᵢ₊₁−Pᵢ)cos(αᵢ−θ)=0 (4).

(5) The central height hᵢ of the slice and the inclination angle αᵢ of the bottom surface of the slice are measured on the graph of the given slip body, and different θ are selected. With respect to different θ, the safety factor F_{f} that meets the overall force equilibrium is solved according to equation (1), and the safety factor Fₘ that meets the overall moment equilibrium is solved according to equation (4).

(6) The F_{f}−θ relationship curve and the Fₘ−θ relationship curve are drawn based on the F_{f} and Fₘ obtained in step (5), so F and θ that meet the force equilibrium and moment equilibrium at the same time are obtained from the intersection of the two curves, and the corresponding F is the required safety factor (shown in FIG. 9).

Embodiment 2: A slope stability limit equilibrium calculation method based on distribution characteristics of an interslice normal force includes the following specific steps.

(1) A given slip body is vertically divided into a plurality of slices of equal width (shown in FIG. 1). In the traditional limit equilibrium Spencer method, the schematic diagram of the forces acting on the i^{th} slice of the calculation model of the Spencer method is shown in FIG. 2, assuming that the forces between the slices are parallel to each other, that is, θᵢ=θ is a constant, the interslice resultant force ΔP between two sides of the slice is the difference between the interslice forces of the two sides of the slice, and is expressed as:

$$Δ {P}_{i} = {P}_{i + 1} - {P}_{i} = \frac{\frac{{c}_{i} {l}_{i}}{F} + \frac{tan {φ}_{i}}{F} {W}_{i} cos {α}_{i} - {W}_{i} sin {α}_{i}}{cos ( {α}_{i} - θ ) [ 1 + \frac{tan {φ}_{i}}{F} tan ( {α}_{i} - θ ) ]} . \qquad ( 1 )$$

(2) When the slip surface is a circular arc slip surface, with respect to the entire slope, the sum of the interslice resultant forces of the slices is 0, that is:

Σ(Pᵢ₊₁−Pᵢ)=0 (2).

(3) In the process of solving the moment equilibrium of the slice, assuming that the interslice resultant force ΔP of each slice acts on the bottom surface of the slice, the tangential component force of the interslice resultant force ΔP on the slip surface is (Pᵢ₊₁−Pᵢ)cos(αᵢ−θ), the force arm from the tangential component force to the rotation center O is Rᵢ, and the overall moment equilibrium equation is established as:

Σ(Pᵢ₊₁−Pᵢ)cos(αᵢ−θ)Rᵢ=0 (3).

(4) The interslice normal force along the depth of the slice presents a triangular distribution (shown in FIG. 4). According to the definite integral and the resultant moment principle, when the interslice normal force along the depth of the slice presents the triangular distribution, the acting point of the resultant force is located at ⅓ above the bottom of the slice, and the force arm from the tangential component force of the interslice resultant force ΔP on the slip surface to the rotation center O is expressed as:

Rᵢ =Rᵢ−½hᵢ cos αᵢ (4)

R″ of the equation (4) is substituted into the equation (3), then the overall moment equilibrium equation is established as:

ΣΔP cos(αᵢ−θ)(Rᵢ−⅓hᵢ cos αᵢ)=0 (5)

where, hᵢ is the height of the slice.

(5) The central height hᵢ of the slice and the inclination angle αᵢ of the bottom surface of the slice are measured on the graph of the given slip body, and different θ are selected. With respect to different θ, the safety factor F_{f} that meets the overall force equilibrium is solved according to equation (1), and the safety factor Fₘ that meets the overall moment equilibrium is solved according to equation (5).

(6) The F_{f}−θ relationship curve and the Fₘ−θ relationship curve are drawn based on the F_{f} and Fₘ obtained in step (5), so F and θ that meet the force equilibrium and moment equilibrium at the same time are obtained from the intersection of the two curves, and the corresponding F is the required safety factor (shown in FIG. 9).

Embodiment 3: A slope stability limit equilibrium calculation method based on distribution characteristics of an interslice normal force includes the following specific steps.

(1) A given slip body is vertically divided into a plurality of slices of equal width (shown in FIG. 1). In the traditional limit equilibrium Spencer method, the schematic diagram of the forces acting on the i^{th} slice of the calculation model of the Spencer method is shown in FIG. 2, assuming that the forces between the slices are parallel to each other, that is, θᵢ=θ is a constant, the interslice resultant force ΔP between two sides of the slice is the difference between the interslice forces of the two sides of the slice, and is expressed as:

$$Δ {P}_{i} = {P}_{i + 1} - {P}_{i} = \frac{\frac{{c}_{i} {l}_{i}}{F} + \frac{tan {φ}_{i}}{F} {W}_{i} cos {α}_{i} - {W}_{i} sin {α}_{i}}{cos ( {α}_{i} - θ ) [ 1 + \frac{tan {φ}_{i}}{F} tan ( {α}_{i} - θ ) ]} . \qquad ( 1 )$$

(2) When the slip surface is a circular arc slip surface, with respect to the entire slope, the sum of the interslice resultant forces of the slices is 0, that is:

Σ(Pᵢ₊₁−Pᵢ)=0 (2).

(3) In the process of solving the moment equilibrium of the slice, assuming that the interslice resultant force ΔP of each slice acts on the bottom surface of the slice, the tangential component force of the interslice resultant force ΔP on the slip surface is (Pᵢ₊₁−Pᵢ)cos(αᵢ−θ), the force arm from the tangential component force to the rotation center θ is Rᵢ, and the overall moment equilibrium equation is established as:

Σ(Pᵢ₊₁−Pᵢ)cos(αᵢ−θ)Rᵢ=0 (3).

(4) The interslice normal force along the depth of the slice presents a uniform distribution (shown in FIG. 3), a trapezoidal distribution (shown in FIG. 5) or a half-sine distribution (shown in FIG. 6). According to the definite integral and the resultant moment principle, when the interslice normal force along the depth of the slice presents the uniform distribution, the trapezoidal distribution or the half-sine distribution, the acting point of the resultant force is located at ½ above the bottom of the slice, and the force arm from the tangential component force of the interslice resultant force ΔP on the slip surface to the rotation center O is expressed as:

Rᵢ′=Rᵢ−½hᵢ cos αᵢ (4)

Rᵢ′ of the equation (4) is substituted into the equation (3), then the overall moment equilibrium equation is established as:

ΣΔP cos(αᵢ−θ)(Rᵢ−⅓hᵢ cos αᵢ)=0 (5)

where, hᵢ is the height of the slice.

(5) The central height hᵢ of the slice and the inclination angle αᵢ of the bottom surface of the slice are measured on the graph of the given slip body, and different θ are selected. With respect to different θ, the safety factor F_{f} that meets the overall force equilibrium is solved according to equation (1), and the safety factor Fₘ that meets the overall moment equilibrium is solved according to equation (5).

(6) The F_{f}−θ relationship curve and the Fₘ−θ relationship curve are drawn based on the F_{f} and Fₘ obtained in step (5), so F and θ that meet the force equilibrium and moment equilibrium at the same time are obtained from the intersection of the two curves, and the corresponding F is the required safety factor (shown in FIG. 9).

A shallow arc slip model with a slope angle of 45° and a slope height of 20 m is established, as shown in FIG. 10, and its mechanical parameters are shown in Table 1,

TABLE 1
Rock mass strength parameters

| | mechanical parameters | | |
|---|---|---|---|
| | | cohesive | internal friction |
| | weight/ | force/ | angle/ |
| lithology | (kN/m³) | (kPa) | (°) |
| miscellaneous fill | 19 | 25 | 20 |

The traditional Spencer method of the comparative example and the slope stability limit equilibrium calculation method based on distribution characteristics of an interslice normal force of Embodiments 2 and 3 are separately adopted to solve the safety factor of the slope. In Embodiment 2, assuming that the interslice normal force along the depth of the slice presents a triangular distribution, then the interslice resultant force acts on ⅓ above the bottom of the slice. In Embodiment 3, assuming that the interslice normal force along the depth of the slice presents a uniform distribution, a trapezoidal distribution or a half-sine distribution, then the interslice resultant force acts on ½ above the bottom of the slice. The traditional Spencer method of the comparative example and the slope stability limit equilibrium calculation method based on distribution characteristics of an interslice normal force of Embodiments 2 and 3 are separately adopted to calculate the slip surfaces 1, 2 and 3. In the table, Fₛ represents the safety factor calculated by the traditional Spencer method of the comparative example, Fₛ₁ represents the safety factor of the slope stability limit equilibrium calculation method based on the distribution characteristics of the interslice normal force of Embodiment 2, and Fₛ₂ represents the safety factor of the slope stability limit equilibrium calculation method based on the distribution characteristics of the interslice normal force of Embodiment 3. Δ1 represents the change between the safety factor of the slope stability limit equilibrium calculation method based on the distribution characteristics of the interslice normal force of Embodiment 2 and the safety factor calculated by the traditional Spencer method, and Δ2 represents the change between the safety factor of the slope stability limit equilibrium calculation method based on the distribution characteristics of the interslice normal force of Embodiment 3 and the safety factor calculated by the traditional Spencer method. The calculation results are shown in Table 2.

TABLE 2
Comparison table of the calculation results
of comparative example, Embodiment 2
and Embodiment 3

| | safety factor | | |
|---|---|---|---|
| | | Embodiment 2 | Embodiment 3 |
| slip surface | Fₛ | Fₛ₁ ( [symbol] 1) | Fₛ₂ ( [symbol] 2) |
| 1 | 1.03 | 1.04(1.0%) | 1.04(1.0%) |
| 2 | 1.06 | 1.08(1.9%) | 1.09(2.8%) |
| 3 | 1.20 | 1.24(3.3%) | 1.26(5.0%) |

It can be known from Table 2 that when the slope is a shallow slip, the distribution of the interslice normal force has a certain influence on the safety factor. As the position of the acting point of the interslice force rises, the safety factor increases, but the change is not obvious. The calculation results of the safety factor F of the slip surface 3 of the shallow slip model according to the Embodiments 2 and 3 and comparative example are shown in FIG. 11. It can be known from FIG. 11 that the safety factor curve of the moment equilibrium is approximately horizontal, indicating that the interslice tangential force has little influence on the safety factor of the slope; while the safety factor curve of the force equilibrium rises monotonically, that is, the force safety factor increases with the increase of θ as the interslice tangential force increases, indicating that the safety factor of the force equilibrium is relatively sensitive to the interslice tangential force, and unreasonable assumptions will cause serious errors. In addition, considering the different distribution of the interslice normal force, as the position of the acting point of the resultant force rises, the angle θ of the interslice force corresponding to the final safety factor increases, that is, the influence of the interslice tangential force on the slope stability increases.

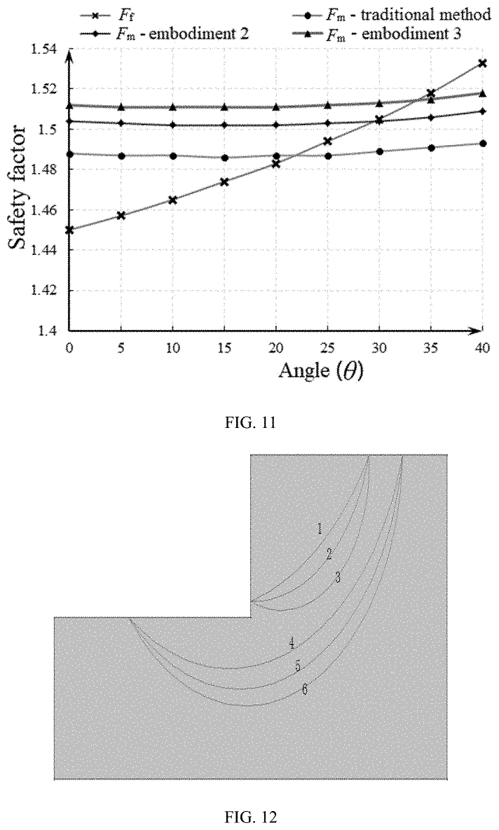

Referring to FIG. 12, a deep foundation pit slip model is established. The depth of the foundation pit is 20 m, and the mechanical parameters are shown in Table 1. The position of the slip surface due to the instability of the foundation pit mainly includes two types, one type is located on the wall of the foundation pit, such as slip surface 1, slip surface 2, and slip surface 3 in FIG. 12. The other type penetrates the bottom of the foundation pit, such as slip surface 4, slip surface 5 and slip surface 6 in FIG. 12. The traditional Spencer method of the comparative example and the slope stability limit equilibrium calculation method based on distribution characteristics of an interslice normal force of Embodiments 2 and 3 are separately adopted to calculate the slip surfaces 1, 2, 3, 4, 5 and 6, and the calculation results are shown in Table 3.

TABLE 3
Comparison table of the calculation results of different methods

| | safety factor | | |
|---|---|---|---|
| | | Embodiment 2 | Embodiment 3 |
| slip surface | Fₛ | Fₛ₁ ( [symbol] 1) | Fₛ₂ ( [symbol] 2) |
| 1 | 0.97 | 0.96(−1.0%) | 0.96(−1.0%) |
| 2 | 1.26 | 1.21(−4.0%) | 1.19(−5.6%) |
| 3 | 2.00 | 1.79(−10.5%) | 1.64(−18.0%) |
| 4 | 1.43 | 1.47(2.8%) | 1.5(4.9%) |
| 5 | 1.58 | 1.65(4.4%) | 1.69(7.0%) |
| 6 | 1.74 | 1.84(5.7%) | 1.91(9.8%) |

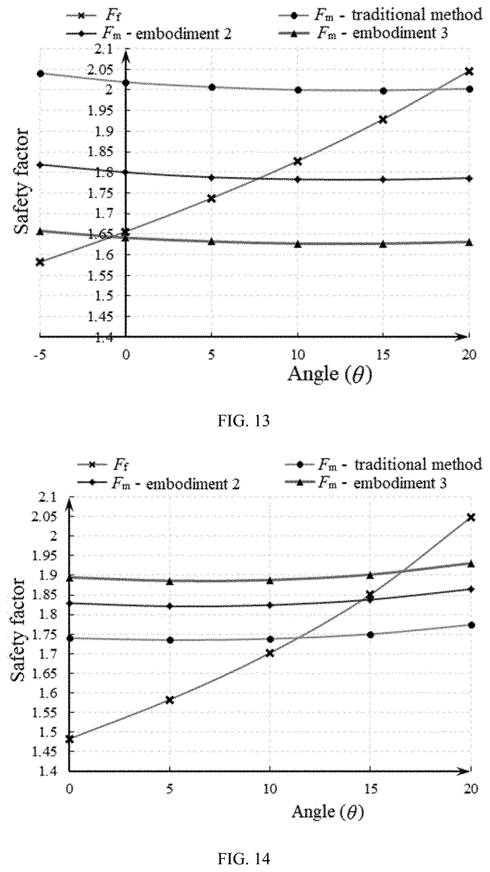

It can be known from Table 3 that with respect to the deep foundation pit engineering, when the slip surface is located on the pit wall, as the position of the acting point of the interslice force rises, the safety factor decreases, and the maximum decreasing amplitude can reach 18%; when the slip surface penetrates the pit bottom, as the position of the acting point of the interslice force rises, the safety factor increases, and the maximum increasing amplitude can reach about 10%. The calculation results of the safety factor F of the slip surface 3 of the deep slip model according to Embodiments 2 and 3 and comparative example are shown in FIG. 13. The calculation results of the safety factor F of the slip surface 6 of the deep slip model according to Embodiments 2 and 3 and comparative example are shown in FIG. 14. In addition, compared with the shallow slip surface, the moment safety factor of the deep slip surface is more sensitive to the change of the interslice tangential force, and the safety factor curve of the force equilibrium still rises monotonously and approximately presents a proportional relationship. Considering the different distribution of the interslice normal force, when the slip surface is located on the pit wall, as the position of the acting point of the resultant force rises, the angle θ of the interslice force corresponding to the final safety factor decreases, that is, the influence of the interslice tangential force on the slope stability decreases. When the slip surface penetrates the pit bottom, as the position of the acting point of the resultant force rises, the angle θ of the interslice force corresponding to the final safety factor increases, that is, the influence of the interslice tangential force on the slope stability increases.

Embodiment 4: According to the case of a deep foundation pit in the literature “Yong Z H O U, Nan G U O, Xiaohui YANG, et al. Deformation analysis and reinforcement of excessive excavation of a deep foundation pit supported by pile anchors [J]. Chinese Journal of Underground Space and Engineering, 2015 (S1): 211-216”, the final excavation depth of the foundation pit is −15.7 m, and the stratum distribution from top to bottom is the miscellaneous fill layer, collapsible loess layer, non-collapsible loess layer and pebble layer. The thickness and physical and mechanical parameters of each soil layer are shown in Table 4.

TABLE 4
Physical and mechanical parameters of each soil layer

| | mechanical parameters | | | |
|---|---|---|---|---|
| | | | | internal |
| | thickness/ | weight/ | cohesive | friction |
| soil layer | (m) | (kN/m³) | force/(kPa) | angle/(°) |
| miscellaneous fill layer | 2.5 | 17 | 5 | 21 |
| collapsible loess layer | 11 | 15 | 2 | 27 |
| non-collapsible loess layer | 6 | 16 | 18 | 25 |
| pebble layer | 5.5 | 21 | 0 | 35 |

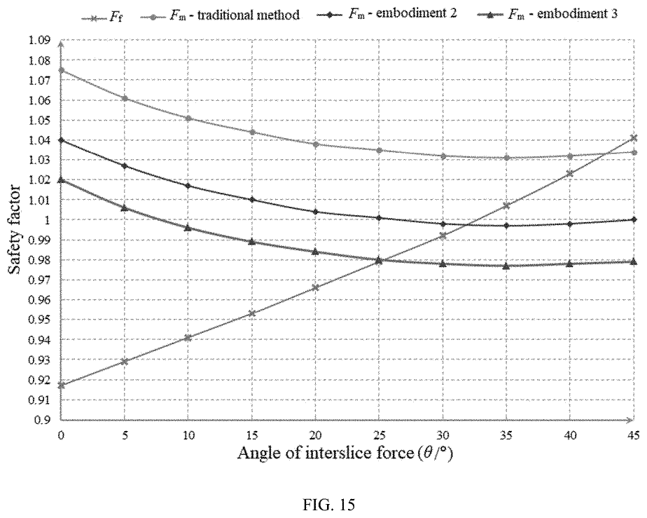

The traditional Spencer method of the comparative example and the slope stability limit equilibrium calculation method based on distribution characteristics of an interslice normal force of Embodiments 2 and 3 are separately adopted to calculate the stability of this foundation pit, and the calculation results are shown in FIG. 15. It can be known from FIG. 15 that the safety factor calculated by the traditional Spencer method is 1.03>1. Although it does not meet the specification requirements, it is still in a stable state; while the calculation result of the slope stability limit equilibrium calculation method based on the distribution characteristics of the interslice normal force according to Embodiment 2 is 0.997, and the calculation result of the slope stability limit equilibrium calculation method based on the distribution characteristics of the interslice normal force according to Embodiment 3 is 0.980, both of which are less than 1, so slumping occurs. Therefore, the calculation result of the traditional Spencer method is not advantageous to engineering safety, while the improved Spencer method considering the distribution of the interslice normal force according to Embodiments 2 and 3 is more realistic.

Embodiment 5: According to the case of a high slope in the literature “Qingrong S H E. Optimization design of a deep foundation pit supporting structure in Jianyang [J]. Fujian Architecture, 2018, 1: 46-49.”, the height of the slope is 12 m, the slope is divided into two grades to excavate, the height of each grade is 6 m, the slope ratio is 1:1, the overload value of the top of the slope is 15 kPa, and the soil layers are mainly plain fill and fully weathered schist. The thickness and the physical and mechanical parameters of each soil layer are shown in Table 5.

TABLE 5
Physical and mechanical parameters of each soil layer

| | mechanical parameters | | | |
|---|---|---|---|---|
| | thickness/ | weight/ | cohesive | internal friction |
| soil layer | (m) | (kN/m³) | force/(kPa) | angle/(°) |
| plain fill | 2.5 | 17 | 5 | 21 |
| fully weathered | 11 | 15 | 2 | 27 |
| schist | | | | |

There are two main designed supporting schemes: \textcircled{1}Four rows of anchor rods with lengths of 12 m, 12 m, 15 m and 18 m are arranged on the first-grade slope; three rows of anchor rods with a length of 18 m are arranged on the second-grade slope; except that the single-hole designed tensions of two anchor rods in the bottom are 80 kN, the rest are all 100 kN; and \textcircled{2}Two rows of anchor cables with a length of 15 m and a designed tension of 100 kN are arranged on the first-grade slope, and two rows of anchor cables with a length of 15 m and a designed tension of 80 kN are arranged on the second-grade slope. The anchor rods have a horizontal spacing of 1.2 m and a vertical spacing of 1.5 m.

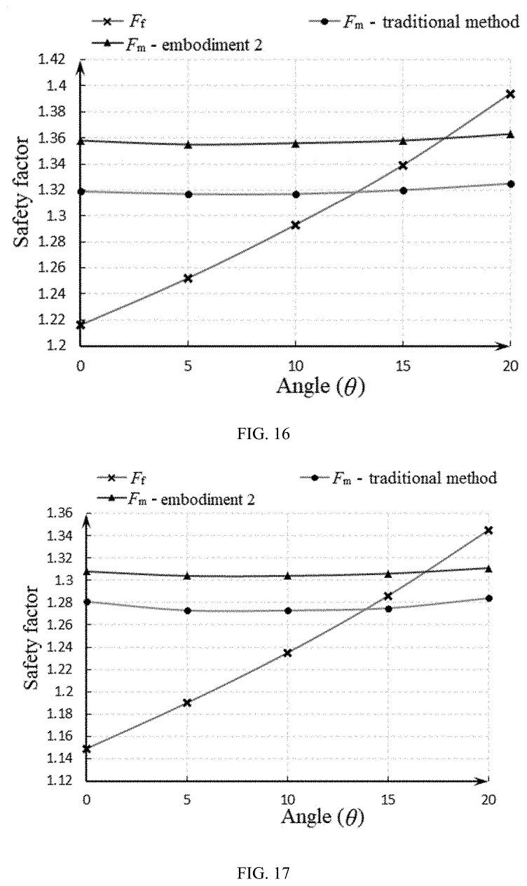

The calculation methods of Embodiment 2 and comparative example were separately adopted to verify the supporting effects of the two supporting schemes, the comparison diagrams of the calculation results of the stability are separately shown in FIG. 16 (scheme 1) and FIG. 17 (scheme 2). It can be known from the figures that by means of the traditional Spencer method, the calculation result of the safety factor of the reinforced slope in scheme 1 is 1.32>1.30, which meets the specification requirements, and the calculation result of the reinforced slope in scheme 2 is 1.27<1.30, which does not meet the specification requirements. Therefore, actual engineering selects the supporting scheme 1 to support the slope.

However, the region of the slip body is mainly the plain fill, assuming that the interslice normal force presents a triangular distribution, the calculation method of Embodiment 2 is selected. Hence, the improved Spencer method is adopted to calculate the reinforcement effects of the two schemes as follows: the calculation result of the reinforced slope in scheme 1 is 1.36>1.30, which meets the specification requirements; the calculation result of the reinforced slope in scheme 2 is 1.31>1.30, which also meets the specification requirements. Therefore, if the calculation method of Embodiment 2 is adopted for calculation, the supporting costs of the engineering can be saved by nearly 50%, and the economic benefits are more objective.

The specific embodiments of the present invention are described in detail above, but the present invention is not limited to the above-mentioned embodiments, and within the scope of knowledge possessed by those having ordinary skill in the art, various changes can be made without departing from the purpose of the present invention.

What is claimed is:

1. A slope stability limit equilibrium calculation method based on distribution characteristics of an interslice normal force, comprising the following steps:
(1) vertically dividing a given slip body into a plurality of slices of an equal width, wherein in a traditional limit equilibrium Spencer method, assuming that forces between the plurality of slices are parallel to each other, θᵢ=θ is a constant, an interslice resultant force ΔP between two sides of each slice of the plurality of slices is a difference between interslice forces of the two sides of the each slice, and the interslice resultant force ΔP is expressed as:
$$Δ {P}_{i} = {P}_{i + 1} - {P}_{i} = \frac{\frac{{c}_{i} {l}_{i}}{F} + \frac{tan {φ}_{i}}{F} {W}_{i} cos {α}_{i} - {W}_{i} sin {α}_{i}}{cos ( {α}_{i} - θ ) [ 1 + \frac{tan {φ}_{i}}{F} tan ( {α}_{i} - θ ) ]} \qquad equation ( 1 )$$
where, ΔPᵢ is an interslice resultant force between two sides of an i^{th} slice, Pᵢ is an interslice force of the i^{th} slice, Pᵢ₊₁ is an interslice force of an (i+1)^{th} slice, Eᵢ is a normal component force of Pᵢ, cᵢ is a cohesive force of the i^{th} slice, lᵢ is a length of a bottom surface of the i^{th} slice, F is a safety factor, Wᵢ is a weight of the i^{th} slice, φᵢ is an internal friction angle of the i^{th} slice, and θᵢ is the angle between the interslice force Pᵢ and the normal component force Eᵢ; the forces between the plurality of slices are parallel to each other, and θᵢ=θ is the constant;
(2) when a slip surface is a circular arc slip surface, with respect to an entire slope, summing interslice resultant forces of the plurality of slices to be 0, wherein the sum of the interslice resultant forces of the plurality of slices is expressed as:
Σ(Pᵢ₊₁−Pᵢ)=0 equation (2);
(3) in a process of solving a moment equilibrium of the each slice, assuming that the interslice resultant force ΔP of the each slice acts on the bottom surface of the each slice, wherein a tangential component force of the interslice resultant force ΔP on the slip surface is expressed as (Pᵢ₊₁−Pᵢ)cos(αᵢ−θ), and a force arm from the tangential component force to a rotation center O is expressed as Rᵢ, and establishing an overall moment equilibrium equation as:
Σ(Pᵢ₊₁−Pᵢ)cos(αᵢ=θ)Rᵢ=0 equation (3);
(4) since the interslice normal force along a depth of the each slice presents a uniform distribution, a triangular distribution, a trapezoidal distribution or a half-sine distribution, according to a definite integral and a resultant moment principle, when the interslice normal force along the depth of the each slice presents the uniform distribution, the trapezoidal distribution or the half-sine distribution, determining that an acting point of the interslice resultant force is located at ½ hᵢ above the bottom surface of the each slice, wherein the force arm from the tangential component force of the interslice resultant force ΔP on the slip surface to the rotation center O is expressed as:
Rᵢ′=Rᵢ−½hᵢ cos αᵢ equation (4);
when the interslice normal force along the depth of the each slice presents the triangular distribution, determining that the acting point of the interslice resultant force is located at ⅓ hᵢ above the bottom surface of the each slice, wherein the force arm from the tangential component force of the interslice resultant force ΔP on the slip surface to the rotation center O is expressed as:
Rᵢ″=Rᵢ−⅓hᵢ cos αᵢ equation (5);
substituting Rᵢ′ of the equation (4) into the equation (3), and establishing the overall moment equilibrium equation as:
ΣΔP cos(αᵢ−θ)(Rᵢ−½hᵢ cos αᵢ)=0 equation (6);
substituting Rᵢ″ of the equation (5) into the equation (3), and establishing the overall moment equilibrium equation as:
ΣΔP cos(αᵢ−θ)(Rᵢ−⅓hᵢ cos αᵢ)=0 equation (7);
where, hᵢ is a central height of the each slice;
(5) measuring the central height hᵢ of the each slice and an inclination angle αᵢ of the bottom surface of the each slice on a graph of the given slip body, and selecting different θ; with respect to the different θ, solving a safety factor F_{f} meeting the overall force equilibrium equation according to the equation (1), and solving a safety factor Fₘ meeting the overall moment equilibrium equation according to the equation (6) or the equation (7); and
(6) drawing a F_{f}−θ relationship curve based on the F_{f} obtained in step (5) and a Fₘ−θ relationship curve based on the Fₘ obtained in step (5), obtaining F and θ from an intersection of the F_{f}−θ relationship curve and the Fₘ−θ relationship curve, wherein the F and the θ meet the overall force equilibrium equation and the overall moment equilibrium equation at a same time, and F is the safety factor corresponding to the overall force equilibrium equation and the overall moment equilibrium equation.
